(19) United States
(12) Patent Application Publication
(10) Pub. No.: US 2007/0133902 A1
(43) Pub. Date: Jun. 14, 2007

(54) Method and circuit for integrated de-mosaicing and downscaling preferably with edge adaptive interpolation and color correlation to reduce aliasing artifacts

(75) Inventor: Namit Kumar, Sunnyvale, CA (US)

Correspondence Address: Alfred A. Equitz;GIRARD & EQUITZ LLP, Suite 1110, 400 Montgomery Street, San Francisco, CA, 94104, US

(73) Assignee: PortalPlayer, Inc.

(21) Appl. No.: 11/301,516

(22) Filed: Dec. 13, 2005

(51) Int. Cl. G06K 9/32

(52) U.S. Cl. 382/298

(57) ABSTRACT

In a class of embodiments, a method and circuit for de-mosaicing and downscaling image data (e.g., image data in raw Bayer image format) in a single, integrated operation, rather than two separate and sequential de-mosaicing and downscaling operations. Some embodiments of the method include a step of displaying the de-mosaiced and downscaled data (e.g., on an LCD of a digital camera to perform an image preview operation). In typical embodiments, the method includes the steps of: determining sampling points (one sampling point for each output image pixel); and filtering the input image data to generate color component values of output image data (e.g., red, green, and blue color components of output image data in RGB format) at each sampling point without producing unacceptable aliasing artifacts. In typical embodiments, the filtering step implements an edge adaptive interpolation algorithm and performs color correlation between red and green channels and between blue and green channels to reduce aliasing artifacts.

### FIELD OF THE INVENTION

The invention pertains to methods and circuitry for performing de-mosaicing and downscaling of image data (e.g., for digital camera preview applications in which raw image data must be de-mosaiced to be displayed as a color image, and downscaled to be displayed on a small display screen).

### BACKGROUND OF THE INVENTION

One type of conventional digital image sensor array include sensors arranged in a Bayer pattern, as described in U.S. Pat. No. 3,971,065 to Bayer, issued Jul. 20, 1976. Such an array captures images with one primary color per pixel in the sense that each pixel is a red, green, or blue color value. The image data produced by such an array is in a raw Bayer image format and must be processed (to place it in RGB format) before it can be displayed (e.g., on a LCD) as a full color image. FIG. 1 is an exemplary image that would result from displaying image data in raw Bayer image format, without first converting the image data to RGB format. In FIG. 1, pixel G00 (in row 0 and column 0) is a magnitude indicative of green (generated by reading a green sensor), pixel R01 (in row 0 and column 1) is a magnitude indicative of red (generated by reading a red sensor adjacent to the green sensor), pixel B01 (in row 1 and column 0) is a magnitude indicative of blue (generated by reading a blue sensor), pixel G11 (in row 1 and column 1) is a magnitude indicative of green (generated by reading a second green sensor adjacent to the blue sensor), and so on.

An array of image sensors are arranged in a Bayer pattern consists of blocks of laterally offset sensors. Each block consists of two green sensors, a blue sensor, and a red sensor arranged as follows: one row includes a green sensor and a red sensor, another row includes another green sensor and a blue sensor, the green sensors are diagonally offset from each other (i.e., neither of them belongs to the same row or the same column) and the red sensor is diagonally offset from the blue sensor.

The conversion of image data in raw Bayer image format to image data in RGB format (3 colors per pixel) is called “de-mosaicing,” “color interpolation,” or “Bayer to RGB conversion.”

Another operation performed on image data (in raw Bayer image format, or RGB format, or other formats) is known as scaling. To scale an M×N array of pixels, an M′×N′ array of pixels is generated, such that M≠M′ and/or N≠N′, and the image determined by the M′×N′ pixel array has a desired display resolution. Both scaling and de-mosaicing implement sample rate conversion. Filtering is typically required after scaling to reduce aliasing, and filtering is also typically required after de-mosaicing to reduce aliasing. Since de-mosaicing requires calculation of missing color values at each pixel location (e.g., red and blue values at pixel location G₀₀ and green and blue values at pixel location R₀₁ of FIG. 1), it typically must be followed by low pass filtering to reduce aliasing artifacts (e.g., false colors, and the zipper effect). Since downscaling requires down-sampling of image data, it typically must be followed by low pass filtering to reduce aliasing artifacts (e.g., jagged edges).

In many applications, it is necessary to perform both scaling and de-mosaicing on image data in raw Bayer image format. For example, it may be necessary to perform both downscaling and de-mosaicing on raw image data (that can be displayed as the image shown in FIG. 1) to generate downscaled and de-mosaiced RGB data that can be displayed as the image shown in FIG. 2.

The FIG. 1 image consists of 2W_{S}×2H_{S} pixels arranged in a single plane with interleaved R,G,B colors, and includes W_{S}×H_{S} red pixels, W_{S}×H_{S} blue pixels, and W_{S}×2H_{S} green pixels. The green channel can be thought of as two logical channels, each consisting of W_{S}×H_{S} pixels: a “GR” consisting of the green pixels in the rows consisting of green and red pixels (e.g., row 0 and row 2); and a “GB” channel consisting of the green pixels in the rows consisting of green and blue pixels (e.g., row 1 and row 3). For example, green pixel G₀₀ in row 0 and column 0 of FIG. 1 is a “GR” pixel, and green pixel G₁₁ in row 1 and column 1 of FIG. 1 is a “GB” pixel.

The RGB image of FIG. 2 consists W_{D}×H_{D} pixels, with each pixel consisting of a red color component, a green color component, and a blue color component. For example, the pixel in row 0 and column 0 of FIG. 2 consists of red color component row, green color component g₀₀, and blue color component b₀₀, and the pixel in row 0 and column 1 of FIG. 2 consists of red color component r₀₁, green color component g₀₁, and blue color component b₀₁.

The commercially important digital camera preview (view-finding) application is typically performed by capturing continuous raw image data frames followed by de-mosaicing, image signal processing and downscaling of the image data for display on an LCD (liquid crystal display). The resolution of the LCD of a digital camera is typically much smaller (typically 2× to 6× reduction) than the image capture resolution and much computation is wasted if downscaling is the final one of the noted operations to be performed. However, if scaling is performed before de-mosaicing, the result is loss of spatial information that is needed for the de-mosaicing. This degrades the quality of the displayed image.

The inventor has recognized that performing de-mosaicing and downscaling sequentially (as a two-stage operation including separate de-mosaicing and downscaling stages) has several disadvantages including the following:
(i) in each operation, sampling points must be computed (so that separate sampling point computations are needed to perform both operations);
(ii) each operation typically must be followed by an additional low pass filtering operation to reduce aliasing, so that sequential (rather than simultaneous) performance of downscaling and de-mosaicing requires two additional filtering operations (rather than only one filtering operation) to reduce aliasing. Conventional filter algorithms that provide good anti-aliasing properties (e.g., those using edge-adaptive interpolation and color correlation) are expensive to implement in hardware;
(iii) row memory is required for both filtering operations;
(iv) if image signal processing (e.g., for color correction, contrast change, and/or noise reduction) is performed before downscaling, it must be performed on a bigger size image than if it is performed after downscaling (requiring more computation and consuming more power). Typically, conventional downscaling is performed immediately after de-mosaicing and before image signal processing (if de-mosaicing, downscaling, and image signal processing are required). In some cases, conventional downscaling is performed after both de-mosaicing and image signal processing due to a design constraint (e.g., where the scaler is an element of a display controller);
(v) if downscaling is performed before de-mosaicing, the downscaling results in loss of spatial information and increased artifacts; and
(vi) if de-mosaicing is performed before downscaling, the filtering needed for reducing the artifacts of interpolation has to be performed on the original size image, significantly increasing the computation and memory requirements.

The inventor has also recognized that both de-mosaicing and downscaling are sample rate conversion operations, and that each of these operations typically must followed by low pass filtering to reduce aliasing artifacts. The present invention exploits the similarity between de-mosaicing and downscaling and provides a technique for combining them into a single sampling and filtering operation.

### SUMMARY OF THE INVENTION

In a class of embodiments, the invention is a method for de-mosaicing and downscaling image data in a single, integrated operation, rather than two separate and sequential de-mosaicing and downscaling operations. In some embodiments in this class, the method accomplishes interpolation (de-mosaicing) and downscaling of image data in raw Bayer image format, and includes the step of displaying the de-mosaiced and downscaled data (e.g., on an LCD or other display of a digital camera) to perform an image preview operation.

In typical embodiments, the inventive method includes the steps of: (1) determining sampling points (one sampling point for each output image pixel); and (2) filtering (of the input image data) to generate color component values of output image data (e.g., red, green, and blue color component values) at each sampling point without producing unacceptable aliasing artifacts. Several benefits (to be discussed herein) result from combining de-mosaicing and downscaling operations into a single stage sampling and filtering operation in accordance with the invention. In typical embodiments of the inventive method, the filtering step implements an edge adaptive interpolation algorithm and performs color correlation between red and green channels and between blue and green channels to reduce aliasing artifacts.

It should be appreciated that step (1) can accomplish windowing (selection of a block of input image data for de-mosaicing in accordance with the invention) as well as selection of sampling points of the input image data that determine locations of pixels of output image data (de-mosaiced and downscaled output image data) to be generated. For example, step (1) can determine W_{D}×H_{D} sampling points of a 2W_{S}×2H_{S} array of input image data pixels (so that the W_{D}×H_{D} sampling points in turn determine W_{D}×H_{D} locations of pixels of downscaled, de-mosaiced output image data to be generated), or step (1) can determine a W_{D}/N×H_{D}/M subset (where “N” and “M” are integers) of such W_{D}×H_{D} array of sampling points such that the W_{D}/N×H_{D}/M subset consists of sampling points of a window (e.g., the lower left quadrant, if N=M=2) of a 2W_{S}×2H_{S} array of input image data pixels. In the latter case, the W_{D}/N×H_{D}/M sampling points determine pixel locations of downscaled, de-mosaiced output image data (to be generated in accordance with the invention) in response to the window of the input image data array.

Embodiments of the invention can be implemented in software (e.g., by an appropriately programmed computer), or in firmware, or in hardware (e.g., by an appropriately designed integrated circuit), or in a combination of at least two of software, firmware, and hardware.

Benefits of typical embodiments of the invention include all or some of the following:
(i) only a single sampling point computation step is needed;
(ii) a single stage filter (which implements color correlation and edge-adaptive interpolation) is sufficient to accomplish both de-mosaicing and downsampling (after performance of a preliminary step of determining the sampling points);
(iii) row memory for only a single filtering operation (rather than two separate filtering operations) is required;
(iv) spatial resolution is effectively used to preserve image quality; and
(vi) filtering for de-mosaicing is performed on a smaller size image requiring much less computation than if it were performed prior to downsampling, and, effectively, both downscaling and de-mosaicing are accomplished without significantly increasing the amount of computation that would be required for de-mosaicing alone.

The inventive integrated approach to de-mosaicing and downscaling is expected to be particularly desirable in applications (e.g., mobile handheld device implementations) in which it is particularly desirable to maximize battery life and minimize logic size.

In typical embodiments of the inventive method, the filtering step (performed after determination of sampling points of the input image data) is a simple edge-adaptive interpolation algorithm utilizing color correlation information to suppress false color artifacts. Such embodiments do not require expensive arithmetic operations and are well suited for hardware implementation.

In other embodiments of the inventive method, the filtering step (performed after determination of sampling points of the input image data) is performed using pixel repetition or bilinear or cubic filtering.

Other aspects of the invention are circuits (e.g., integrated circuits) for implementing any embodiment of the inventive method.

### BRIEF DESCRIPTION OF THE DRAWINGS

FIG. 1 is an image, consisting of 2W_{S}×2H_{S} pixels, that would result from displaying an exemplary set of image data having raw Bayer image format.

FIG. 2 is an image consisting of W_{D}×H_{D} pixels (each pixel consisting of a red color component, a green color component, and a blue color component) that would result from displaying image data in RGB format produced by de-mosaicing and downscaling the image data that are displayed to produce FIG. 1.

FIG. 3 is a block diagram of an embodiment of a circuit for performing an embodiment of the inventive method.

FIG. 4 is a block diagram of an embodiment of Bayer-to-RGB conversion circuit 14 of FIG. 3.

### DETAILED DESCRIPTION OF PREFERRED EMBODIMENTS

In a class of embodiments, the invention is a method for performing de-mosaicing and downscaling on input image data (e.g., 2W_{S}×2H_{S} pixels of input image data) having raw Bayer image format to generate output image data (e.g., W_{D}×H_{D} pixels of output image data) having RGB format, said method including the steps of:

(1) determining sampling points (including one sampling point for each pixel of the output image data) from the input image data; and

(2) filtering the input image data to generate color component values, including a set of color component values for each of the sampling points, each said set of color component values determining a different pixel of the output image data.

Preferably, step (2) is performed without producing unacceptable aliasing artifacts, and step (2) generates a red color component value, a green color component value, and a blue color component value for each of the sampling points. The three color component values for each sampling point determine a pixel of the output image data.

In preferred embodiments, step (1) is performed as follows. A pixel of the output (RGB) image data at row and column indices {n, m} is mapped to a pixel of the input image data at index pair {N, M}, where n and N are row indices and m and M are column indices, the input image data include 2W_{S}×2H_{S} pixels, and the output image data include W_{D}×H_{D} pixels. This mapping is straightforward if no scaling is required. However in the general case in which downscaling is required (when 2W_{S}>W_{D} and/or 2H_{S}>H_{D}) the mapping is done in proportion to the scaling ratio for both coordinate axes:

$$\begin{matrix}N = ⌊ \frac{2 {H}_{S}}{{H}_{D}} * n + 0.5 ⌋ ; and \\ M = ⌊ \frac{2 {W}_{S}}{{W}_{D}} * m + 0.5 ⌋ .\end{matrix}$$

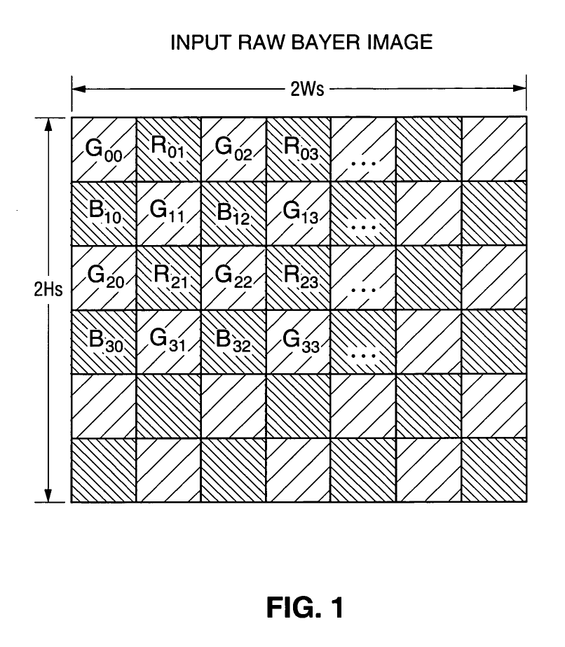

Step (2) can be implemented as follows. A 5×5 block of input data pixels centered at each location {N, M} of the input image is used to calculate the output pixel value at the corresponding location {n, m} of the output image. The calculation is performed in one of two different ways, depending on the color of the input data pixel at location {N, M}. The color of the input data pixel depends on the location {N, M} and the Bayer pattern arrangement, and can be red (R), blue (B), green (GR) when N is indicative of an input image data row consisting of red and green pixels (e.g., N=0 in FIG. 1), or green (GB) when N is indicative of an input image data row consisting of blue and green pixels (e.g., N=1 in FIG. 1). Due to the symmetry between R and B pixels of input image data and the symmetry between GR and GB pixels of input image data, the determination of the output pixel value at location {n, m} is performed in one of two different ways: one way if the input data pixel at location {N, M} is red or blue; and another way if the input data pixel at location {N, M} is green (GR or GB).

To simplify the following description, we sometimes denote the input data pixel at location {N, M} as the “source pixel,” and sometimes denote as the “destination pixel” the pixel of the output image data at the location {n, m} which corresponds to the source pixel location {N, M}.

In an exemplary embodiment, regardless of the color of the source pixel, bi-linear interpolation is performed on a subset of the 5×5 block of input data pixels centered at location {N, M} to determine the green color component (to be referred to as “GI”) of the destination pixel at the corresponding location {n,m}. For example, when the source pixel is a red or blue pixel, the bi-linear interpolation is preferably performed by averaging the four green pixels of the input data nearest to the source pixel, so that GI=(S1+S2+S3+S4)/4, where S1 is the green image data pixel at location {N−1, M−1}, S2 is the green image data pixel at location {N−1, M+1}, S3 is the green image data pixel at location {N+1, M−1}, and S4 is the green image data pixel at location {N+1, M+1}). If the source pixel is a GR or GB pixel, the green color component (GI) of the destination pixel is preferably determined by a bilinear interpolation that averages the source pixel with the four green input data pixels nearest to the source pixel (rather than by setting the GI value of the destination pixel to be equal to the source pixel itself). More specifically, in the exemplary embodiment, if the source pixel is a GR or GB pixel, GI is preferably determined to be GI=(4S+S1+S2+S3+S4)/8, where S is the source pixel, S1 is the green image data pixel at location {N−1, M−1}, S2 is the green image data pixel at location {N−1, M+1}, S3 is the green image data pixel at location {N+1, M−1}, and S4 is the green image data pixel at location {N+1, M+1}. When (as in the exemplary embodiment), the color correlation for red and blue color components of the output image data is determined with green as the reference, it is important to maintain the symmetry in interpolated green color components of the output image data especially at edges and boundaries. This also reduces the aliasing artifacts.

It should be appreciated that in embodiments of the invention other than the exemplary embodiment described herein, interpolation (e.g., bi-linear interpolation) is performed on subsets of the 5×5 block of input data pixels centered at location {N, M} other than the specific subsets described with reference to the exemplary embodiment. For example, the green color component GI of the destination pixel (in the case that the source pixel is a red pixel) could be determined by interpolation of all twelve green pixels in the 5×5 block of input data pixels centered at the source pixel.

After calculating the destination pixel's green color component, the red and blue color components of the destination pixel are calculated. In the exemplary embodiment, depending on the color of the source pixel, this calculation is performed in one of the following two ways (in the following description, the “input image data values” that are processed to determine the red and blue color components are elements of the 5×5 block centered at the source pixel. Each such block includes reflections of input image data values when the source pixel at which it is centered is at or near a vertical and/or horizontal boundary of the input image):

Case (i): For each source pixel (at location {N, M}) which is a red or blue pixel, the sequence of estimating the red color component and blue color component of the destination pixel at the corresponding location {n, m} is preferably as follows:

(a) calculate the horizontal and vertical edge magnitude of the source pixel. More specifically, determine the difference between the input image data values that are vertically nearest to the source pixel (i.e., the input image data values at locations {N+1, M} and {N−1, M}) and the difference between the input image data values that are horizontally nearest to the source pixel (i.e., the input image data values at locations {N, M+1} and {N, M−1});

(b) calculate an interpolated green value “GS” for source pixel location {N, M} by interpolating along any edge of the input image that exists at the source pixel (e.g., the input image has a “vertical” edge if the difference between the magnitudes of the horizontally nearest neighbors of the source pixel is greater than the difference between the magnitudes of the source pixel's vertically nearest neighbors). More specifically, if the absolute value of the difference between the input image data values that are vertically nearest to the source pixel is less than the absolute value of the difference between the input image data values that are horizontally nearest to the source pixel, determine GS by interpolating the input data pixels at locations {N−1, M} and {N+1, M} (i.e., determine that GS=the average of the vertically separated input data pixels at locations {N−1, M} and {N+1, M}). Or, if the absolute value of the difference between the input image data values that are vertically nearest to the source pixel is greater than or equal to the absolute value of the difference between the input image data values that are horizontally nearest to the source pixel, determine GS by interpolating the horizontally separated input data pixels at locations {N, M−1} and {N, M+1} (i.e., determine that GS=the average of the input data pixels at locations {N, M−1} and {N, M+1});

(c) calculate a first one of the destination pixel's red and blue color components (the destination pixel's color component having the same color as the source pixel) by adjusting the source pixel in accordance with the difference between the previously determined GI and GS values. More specifically, if the source pixel is a red pixel, the destination pixel's red color component (R′) is the difference between the source pixel (R) and GS minus GI: R′=R−(GS−GI). Or, if the source pixel is a blue pixel, the destination pixel's blue color component (B′) is the difference between the source pixel (B) and GS minus GI: B′=B−(GS−GI). This adjustment is done to increase the correlation between two of the destination pixel's color components: the green component and the component having the source pixel's color.

(d) generate interpolated values of the other non-green color component of the input image data (i.e., interpolated red values if the source pixel is a blue pixel, or interpolated blue values if the source pixel is a red pixel) by performing interpolation horizontally and vertically for each of the four green input data pixels nearest to the source pixel, where the four green input data pixels nearest to the source pixel are GS1=G{N, M−1}=the green input image data pixel at location {N, M−1}, GS2=G{N, M+1}=the green input image data pixel at location {N, M+1}, GS3=the green input image data pixel at location {N−1, M}, and GS4=the green input image data pixel at location {N+1, M}. Preferably, the interpolated values are NG1=[NG{N−1, M−1}+NG{N−1, M+1}]/2, NG2=[NG{N+1, M−1}+NG{N+1, M+1}]/2, NG3=[NG{−1, M−1}+NG{N+1, M−1}]/2, and NG4=[NG{N−1, M+1}+NG{N−1, M+1}]/2, where “NG{X,Y}” denotes a “non-green” input image data pixel at location {X,Y}. Also, calculate the difference between each interpolated value and each of the green pixels GS1, GS2, GS3, and GS4: D1=GS1−NG3, D2=GS2−NG4, D3=GS3−NG1, and D4=GS4−NG2. In the case that the source pixel is a red pixel, the values NG1, NG2, NG3, and NG4 are interpolated blue pixel values. In the case that the source pixel is a blue pixel, the values NG1, NG2, NG3, and NG4 are interpolated red pixel values; and

(e) estimate the other non-green color component of the destination pixel (i.e., the red color component of the destination pixel if the source pixel is a blue pixel, or the blue color component of the destination pixel if the source pixel is a red pixel) from the difference set determined in step (d) by choosing the one that minimizes the distance with the previously determined GI value. More specifically, if the source pixel is a red pixel, the destination pixel's blue color component (B′) is determined to be
B′=GI−min1(Diff1, Diff2), where

Diff1=D3, if the absolute value of the difference between the input image data values that are vertically nearest to the source pixel is greater than or equal to the absolute value of the difference between the input image data values that are horizontally nearest to the source pixel,

Diff1=D2, if the absolute value of the difference between the input image data values that are vertically nearest to the source pixel is less than the absolute value of the difference between the input image data values that are horizontally nearest to the source pixel,

Diff1=D1, if the absolute value of the difference between the input image data values that are vertically nearest to the source pixel is greater than or equal to the absolute value of the difference between the input image data values that are horizontally nearest to the source pixel,

Diff2=D4, if the absolute value of the difference between the input image data values that are vertically nearest to the source pixel is less than the absolute value of the difference between the input image data values that are horizontally nearest to the source pixel, and

min1(a,b) denotes the one of the values of “a” and “b” having the smallest absolute value.

Similarly, if the source pixel is a blue pixel, the destination pixel's red color component (R′) is determined to be R′=GI−min1(Diff1, Diff2), where min1, Diff1, and Diff2 are defined as in the previous paragraph.

Case (ii): For each source pixel (at location {N, M}) which is a green (GR or GB) pixel, the green color component of the output pixel at the corresponding location {n, m} is preferably determined (as explained above) to be GI=(4S+S1+S2+S3+S4)/8, and a preferred sequence of steps for estimating the red and blue color components of the output pixel at location {n, m} is as follows:

(a) calculate the horizontal and vertical edge magnitude at each of the nearest neighbors (which are red and blue pixels) of the source pixel. More specifically, with the upper neighbor (P1) of the source pixel being the input image data pixel at location {N−1, M} (note: pixel P1 is a red pixel if the source pixel is a GB pixel), the lower neighbor (P2) of the source pixel being the input image data pixel at location {N+1, M}, the left neighbor (P3) of the source pixel being the input image data pixel at location {N, M−1}, and the right neighbor (P4) of the source pixel being the input image data pixel at location {N, M+1}, determine:

D1V=the difference between the input image data values that are vertically nearest to pixel P1 (i.e., the input image data values at locations {N−2, M} and {N, M}),

D1H=the difference between the input image data values that are horizontally nearest to pixel P1 (i.e., the input image data values at locations {N−1, M+1} and {N−1, M−1 }),

D2V=the difference between the input image data values that are vertically nearest to pixel P2 (i.e., the input image data values at locations {N, M} and {N+2, M}),

D2H=the difference between the input image data values that are horizontally nearest to pixel P2 (i.e., the input image data values at locations {N+1, M+1} and {N+1, M−1},

D3V=the difference between the input image data values that are vertically nearest to pixel P3,

D3H=the difference between the input image data values that are horizontally nearest to pixel P3,

D4V=the difference between the input image data values that are vertically nearest to pixel P4, and

D4H=the difference between the input image data values that are horizontally nearest to pixel P4;

(b) calculate interpolated green values GS1 . . . GS4 for the pixels P1, P2, P3, and P4, respectively, by interpolating along any edge (of the input image) that exists at each of pixels P1, P2, P3, and P4. More specifically,

if the absolute value of D1V is less than the absolute value of D1H (i.e., if there is a vertical edge at pixel P1 ), determine GS1 to be the average of the green pixels at locations {N−2, M} and {N, M},

if the absolute value of D1V is greater than or equal to the absolute value of D1H (i.e., if there is a horizontal edge, or no edge, at pixel P1), determine GS1 to be the average of the green pixels at locations {N−1, M−1} and {N−1, M+1},

if the absolute value of D2V is less than the absolute value of D2H, determine GS2 to be the average of the green pixels at locations {N+2, M} and {N, M},

if the absolute value of D2V is greater than or equal to the absolute value of D2H, determine GS2 to be the average of the green pixels at locations {N+1, M−1} and {N+1, M+1},

if the absolute value of D3V is less than the absolute value of D3H, determine GS3 to be the average of the green pixels at locations {N−1, M−1} and {N+1, M−1},

if the absolute value of D3V is greater than or equal to the absolute value of D3H, determine GS3 to be the average of the green pixels at locations {N, M−2} and {N, M},

if the absolute value of D4V is less than the absolute value of D4H, determine GS4 to be the average of the green pixels at locations {N−1, M+1} and {N+1, M+1},

if the absolute value of D4V is greater than or equal to the absolute value of D4H, determine GS4 to be the average of the green pixels at locations {N, M+2} and {N, M};

(c) determine the difference between each nearest neighbor of the source pixel and the corresponding one of the GS1, GS2, GS3, and GS4 values. More specifically, determine Diff1=P1−GS1, Diff2=P2−GS2, Diff3=P3−GS3, and Diff4=P4−GS4; and

(d) estimate the red and blue color components of the destination pixel from the difference set generated in step (c) by choosing the choosing the ones that minimize the distance with the previously determined GI value. More specifically, if the source pixel is a GR pixel, determine the destination pixel's blue color component (B′) and red color component (R′) to be
B′=GI+min1(Diff1, Diff2), and
R′=GI+min1(Diff3, Diff4),

where min1(a,b) denotes the one of the values of “a” and “b” having the smallest absolute value.

And, if the source pixel is a GB pixel, determine the destination pixel's blue color component (B′) and red color component (R′) to be
R′=GI+min1(Diff1, Diff2), and
B′=GI+min1(Diff3, Diff4),

where min1(a,b) denotes the one of the values of “a” and “b” having the smallest absolute value.

In the exemplary embodiment, regardless of the color of the source pixel, the filtering operation for each source pixel at a horizontal boundary and/or vertical boundary of the input image reflects the closest pixel(s) of the same color (as the source pixel) across the boundary as necessary to determine each block of input image pixels (centered at the source pixel) employed to determine the output image pixel corresponding to the source pixel, in the following sense.

The term “reflection” of a pixel having row index “x” and column index “y,” where “x” is outside the range of row indices of the input image (and x=b+d, where “b” is the row index of the nearest input image pixel in the same column as said pixel, and “d” can be positive or negative), herein denotes a pixel of the input image having the same color, same magnitude, and same column index as the pixel, but a row index equal to b−d. Similarly, the term “reflection” of a pixel having row index “x” and column index “y,” where “y” is outside the range of column indices of the input image (and y=b+d, where “b” is the column index of the nearest input image pixel in the same row as said pixel, and “d” can be positive or negative), herein denotes a pixel of the input image having the same color, same magnitude, and same row index as the pixel, but a column index equal to b−d. In the exemplary embodiment, each pixel having color “C” of each block of input image pixels centered at a source pixel and employed to determine the output image pixel corresponding to the source pixel, and having a row index outside the range of row indices of the input image (but having a column index in the range of column indices of the input image), is the reflection of a pixel of the input image having the color “C” in the same column of the input image. Each pixel having color “C” of each block of input image data pixels centered at a source pixel and employed to determine the output image data pixel corresponding to the source pixel, and having a column index outside the range of column indices of the input image (but having a row index in the range of row indices of the input image), is the reflection of a pixel of the input image having the color “C” in the same row of the input image. Similarly, each pixel having color “C” of each block of input image pixels centered at a source pixel and employed to determine the output image pixel corresponding to the source pixel, and having a row index outside the range of row indices of the input image and a column index outside the range of column indices of the input image, is a diagonal reflection of a pixel of the input image (a reflection with respect to a diagonal rather than with respect to a row or a column at a boundary of the input image) that is nearest diagonally to the pixel, has the same color “C” as the pixel, and is in a different row and different column than said pixel.

In preferred embodiments, estimation of the green color component of each pixel of the output image data is done using bilinear interpolation to avoid artifacts at edges. This significantly reduces the zipper effect. Since the output image is a downscaled version of the input image, the loss in sharpness due to interpolation is small. Although this modified form of bilinear interpolation typically removes artifacts such as jagged edges and aliasing from the green channel, it can introduce chrominance artifacts (e.g., red and blue image data may not match well with interpolated green at edges) which should be corrected by using color correlation to calculate the output red and blue image data. Also in preferred embodiments, the green channel is used as a reference to interpolate red and blue color components of the output image data. Even if a source pixel is a green pixel, it is modified to make sure that the green color components of the output image are consistent and symmetric at edges. Having an error-free reference is important to suppress false color artifacts generated by de-mosaicing. Not only is suppression of false color artifacts (generated by de-mosaicing) an important advantage of preferred embodiments that use the green channel as a reference to calculate output red and blue data, but these embodiments also have the important advantage of performing both de-mosaicing and filtering (including downscaling) in a single operation (e.g., a single pass through an image data processing circuit).

Preferably, interpolation for red and blue pixels is done based on the edges in the green channel to minimize chrominance artifacts (false colors).

Preferably, the red and blue pixels of the input image data are also modified to suppress the zipper effect in the individual channels and false colors in the output image.

In accordance with the invention, one set of sampling points (each sampling point being an input image pixel location that corresponds to a pixel location of the output image) for de-mosaicing and downscaling is employed to up-sample the interleaved channels in the Bayer pattern (i.e., to determine red, green, and blue color components at each sampling point of the input image) and downsample the input image size simultaneously.

In variations on the inventive method, scaling and de-mosaicing are performed on input data with any scaling ratio (i.e., either upscaling and de-mosaicing, or downscaling and de-mosaicing, is performed). However, anti-aliasing is best accomplished in accordance with the invention in the case of downscaling.

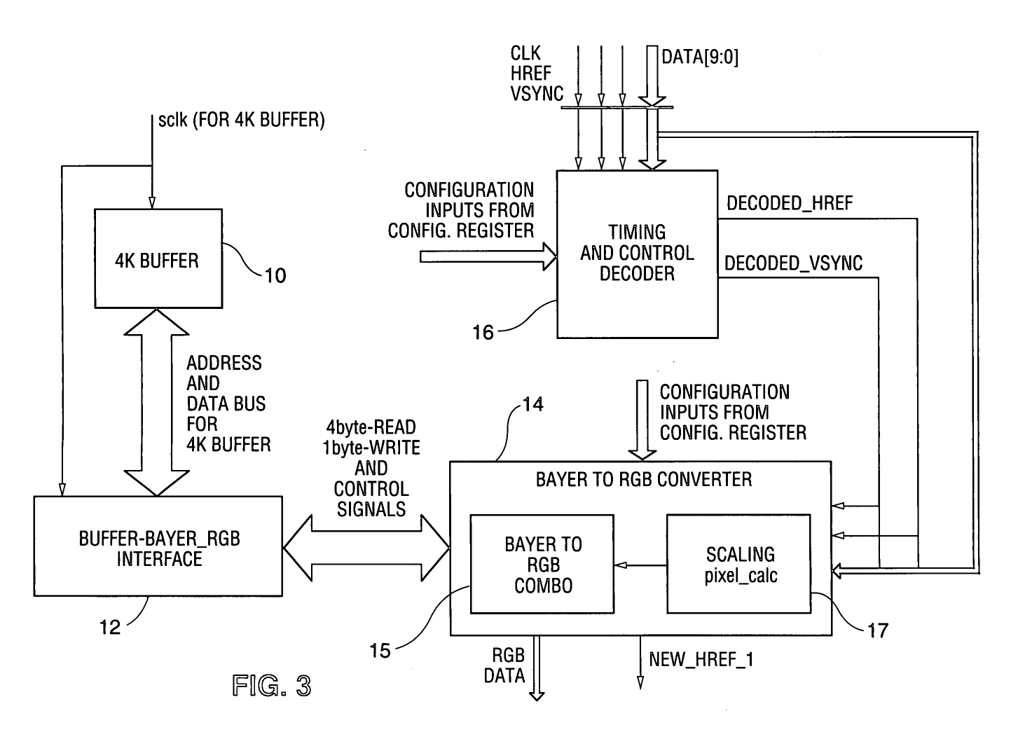

FIG. 3 is a block diagram of an embodiment of a circuit (which it implemented as an integrated circuit or portion of an integrated circuit) for performing an embodiment of the inventive method. The FIG. 3 circuit receives a stream of 10-bit pixels “data[9:0]” of input image data from an image sensor (not shown). The input image data are indicative of an input image (a 2W_{S}×2H_{S} array of pixels, as shown in FIG. 1) and are in raw Bayer image format. The FIG. 3 circuit also receives an input image data clock “clk,” an input image data horizontal sync signal “href,” and an input image data vertical sync signal “vsync.”

In a typical implementation, input image data horizontal and vertical sync signals “href” and “vsync” are typically encoded in ITU-R BT.601/656 format. Timing and control decoder 16 decodes them to generate decoded horizontal sync “Decoded_HREF” and vertical sync “Decoded_VSYNC” bits in a format suitable for use by Bayer-to-RGB conversion circuit 14 (e.g., so the format of the decoded bits does not depend on the image sensor's mode of operation and the values of the configuration bits asserted to configure decoder 16 ), and decoder 16 asserts the “Decoded_HREF” and “Decoded_VSYNC” bits to conversion circuit 14.

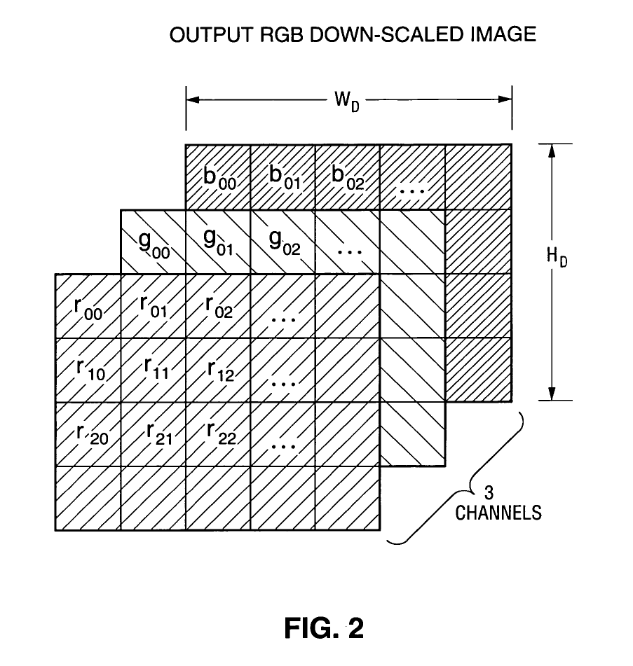

Bayer-to-RGB conversion circuit 14 receives pixels “data[9:0]” of input image data and performs de-mosaicing and downscaling thereon in accordance with the invention to generate a stream of output image data (“RGB data”) indicative of an output image (a W_{D}×H_{D} array of pixels having RGB format, as shown in FIG. 2). Conversion circuit 14 also generates an output image data horizontal sync signal “New_HREF_1” for the output image data. Conversion circuit 14 includes scaling pixel calculation subsystem 17 which determines sampling points for the input image data (one sampling point for each pixel of output image data “RGB data”) and Bayer-to-RGB filtering circuit 15, connected as shown. Circuit 15 generates each RGB pixel (a set of red, green, and blue color component values) of the output image data in response to a 5×5 block of input image data pixels. More specifically, circuit 15 generates each RGB pixel (of the output image data) at an output image location which corresponds to a sampling point (of the input image data) in response to a 5×5 block of input image data pixels “data[9:0]” centered at a source pixel at the sampling point.

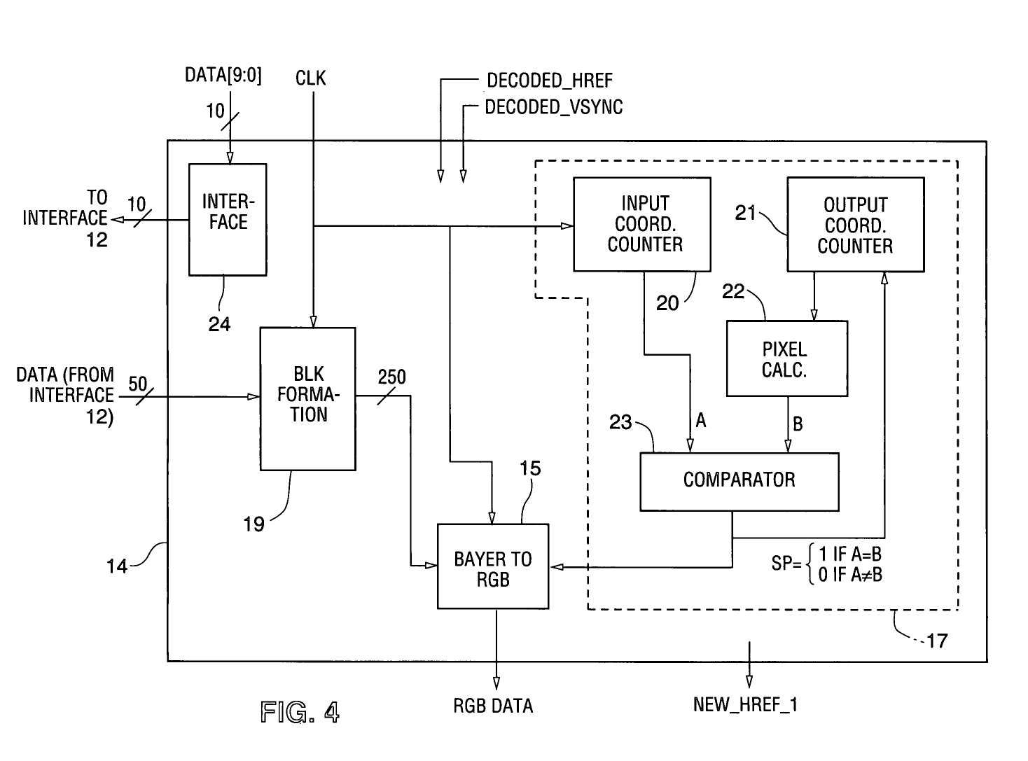

FIG. 4 is a block diagram of an embodiment of Bayer-to-RGB conversion circuit 14 of FIG. 3. The FIG. 4 embodiment of circuit 14 includes input image data interface 24, input image data block forming circuit 19, Bayer-to-RGB filtering circuit 15, input image coordinate counter 20, output image coordinate counter 21, source pixel calculation circuitry 22, and comparator 23, connected as shown. Counters 20 and 21, circuitry 22, and comparator 23, together implement scaling pixel calculation subsystem 17 of FIG. 3.

Bayer-to-RGB conversion circuit 14 asserts the input image data pixels data[9:0] to buffer interface 12 at the rate of one input image data pixel per cycle of input image data clock “clk.”

Buffer interface 12 operates in two clock domains, in response to the input image data clock “clk” and a system clock “sclk.” System clock “sclk” has a rate that is at least twice the rate of clock “clk.”

Buffer 10 is coupled to interface 12 and has capacity to store four rows of input image data pixels data[9:0] (sometimes referred to as “input data” pixels). In response to system clock “sclk,” interface 12 writes to buffer 10 each row of input data pixels that is forwarded to interface 12 from circuit 14, at the rate of one input data pixel per cycle of clock “sclk.” In response to clock “sclk,” interface 12 reads words of input image data from buffer 10 at the rate of one word per cycle of clock “sclk,” each said word being indicative of four image data pixels “data” all in the same column of the input image and each in a different one of four adjacent rows of the input image. In operation, interface 12 (with buffer 10 ) performs both a write of one pixel of input data “data[9:0]” to buffer 10 and a read of one word of buffered input data pixel (the latter word being indicative of four, 10-bit pixels of “data[9:0]”) per cycle of clock “clk” (i.e., per two cycles of clock “sclk”).

Interface 12 generates (and asserts to buffer 10 ) address and control signals for implementing the described read and write operations. Typically, interface 12 includes synchronization circuitry adequate for proper operation of its elements that operate in the input image data clock “clk” domain and its elements that operate in the system clock “sclk” domain.

In a typical implementation, buffer 10 can store 4×1024 pixels of input image data (i.e., four rows of an input image having 1024 pixels per row. For example, four rows of an input image determined by the upper 8-bits “data[9:2]” of each 10-bit pixel “data[9:0]” of FIG. 3) and in this case is sometimes referred to as a “4K” buffer. In other implementations, buffer 10 is configured to store 4×W pixels of input image data, where W is an integer.

Interface 12 preferably includes packing circuitry which combines (concatenates) each word of buffered input data pixels read from buffer 10 (each such word being indicative of four pixels of “data[9:0]” which are elements of a single column and four adjacent rows x, x+1, x+2, and x+3 of the input image) with the most recently received (not yet buffered) input data pixel from circuit 14. The latter pixel is an element of row x+4 of the input image. In such preferred implementations, the packing circuitry of interface 12 asserts (once per cycle of clock “clk” ) an input image data word indicative of five image data pixels “data[9:0]” (all in the same column of the input image and each in a different one of five adjacent rows of the input image) to Bayer-to-RGB conversion circuit 14. More specifically, once per cycle of clock “clk,” such an implementation of interface 12 asserts to block forming circuit 19 (of circuit 14 ) a 50-bit input image data word (as shown in FIG. 4) indicative of five image data pixels “data[9:0]” (all in the same column of the input image and each in a different one of five adjacent rows of the input image).

It should be appreciated that each pixel of input image data may consist of fewer than 10 bits (e.g., 8 bits). The described circuit implementation can be used to de-mosaic and downscale such data, as well as to de-mosaic and downscale input image data consisting of 10-bit pixels. Alternatively, a simpler and less expensive circuit implementation (capable only of de-mosaicing and downscaling input image data consisting of 8-bit pixels) could be used.

Once per cycle of clock “clk,” image data interface 24 (of the FIG. 4 embodiment of Bayer-to-RGB conversion circuit 14) asserts to interface 12 the next input image pixel “data[9:0].” Each such input image pixel is clocked into interface 24 from the image sensor (not shown in FIG. 3 or FIG. 4) in response to the clock “clk.” As described above, packing circuitry within interface 12 combines each 40-bit word of buffered input pixel data (indicative of four buffered input image pixels) that has been read from buffer 10 with one such 10-bit input image pixel from interface 24. The packing circuitry within interface 12 asserts the resulting 50-bit words of input image pixel data to input image data block forming circuit 19 (shown in FIG. 4) as described above.

In response to the 50-bit input image data words received from interface 12, block forming circuit 19 (of the FIG. 4 embodiment of Bayer-to-RGB conversion circuit 14 ) outputs 250-bit words to filtering circuit 15 (as indicated in FIG. 4). Each such 250-bit word is indicative of a 5×5 block of input image data pixels. More specifically, each 250-bit word output from circuit 19 is indicative of twenty-five input image data pixels “data[9:0]” located in five adjacent columns and five adjacent rows of the input image.

In response to each word from circuit 19 that is indicative of a 5×5 block of input image pixels centered at a source pixel coinciding with one of the sampling points determined by subsystem 17, filtering circuit 15 generates a pixel of output image data (a red, a green, and a blue color component value of output image data “RGB data”). Filtering circuit 15 does not generate a pixel of output image data in response to any word from circuit 19 that is not indicative of a 5×5 block of input image pixels centered at a source pixel that coincides with one of the sampling points determined by subsystem 17. Circuit 15 generates each pixel of the output image data (RGB data) in response to a 5×5 block of input image data pixels “data[9:0]” centered a sampling point in accordance with the invention (i.e., as explained above). The input image data pixels of each 5×5 pixel block determined by the output of circuit 19 have raw Bayer image format.

Filtering circuit 15 does not generate output image data in response to any 5×5 block of input image pixels unless the block is centered at a sampling point. More specifically, filtering circuit 15 does not generate output image data in response to data (indicative of a 5×5 block of input image pixels) that is asserted to circuit 15 in a cycle of clock “clk” in which the “SP” bit output from comparator 23 (and asserted to circuit 15) has the logical value “0” indicating that the block is centered at an input image pixel that is not a sampling point. But, filtering circuit 15 does generate red, green, and blue color components of a pixel of output image data “RGB data” in response to data (indicative of a 5×5 block of input image pixels) that is asserted to circuit 15 in a cycle of clock “clk” in which the “SP” bit output from comparator 23 has the logical value “1” (indicating that the block is centered at an input image data pixel that is a sampling point).

With reference to FIG. 4, input image coordinate counter 20 includes a row coordinate (row index) counter and a column coordinate (column index) counter, each of which is reset before assertion of the first pixel “data[9:0]” of an input image to circuit 14 (e.g., during a vertical blanking period determined by the “vsync” signal), and each of which is incremented once per cycle of clock “clk.” Output image coordinate counter 21 includes a row coordinate counter and a column coordinate counter, each of which is reset before assertion of the first pixel “data[9:0]” of an input image to circuit 14 (e.g., during a vertical blanking period determined by the “vsync” signal ), and each of which is incremented in response to the output of comparator 23.

Source pixel calculation circuitry 22 includes multiplier and divider logic for generating the row and column coordinates of the next input image pixel that is a sampling point (i.e., the row and column coordinates of the next output image pixel to be determined by circuit 15 ) in response to the output of counter 21. The output of counter 21 is indicative of row and column coordinates {n, m} of the next output image pixel to be determined by circuit 15. In response to the output of counter 21, circuitry 22 generates the row and column coordinates {N, M} of the corresponding pixel of the input image (i.e., the row and column coordinates of the next sampling point of the input image data), as follows:

$$\begin{matrix}N = ⌊ \frac{2 {H}_{S}}{{H}_{D}} * n + 0.5 ⌋ ; and \\ M = ⌊ \frac{2 {W}_{S}}{{W}_{D}} * m + 0.5 ⌋ .\end{matrix}$$

During a configuration operation performed prior to normal operation of the FIG. 4 circuit (in which the FIG. 4 circuit generates the output data “RGB data”) configuration bits indicative of the parameters W_{D}, H_{D}, W_{S}, and H_{S} (the size of the input image and output image) are provided to circuitry 22 to configure it for normal operation.

Comparator 23 (of subsystem 17) generates an output bit (labeled “SP” in FIG. 4) as a result of comparing the row and column coordinates {N, M} of the next sampling point (asserted to comparator 23 by circuitry 22 and indicated as value set “B” in FIG. 4) with the row and column coordinates {N, M} of the current input image pixel (asserted to comparator 23 by counter 20 and indicated as value set “A” in FIG. 4). If the two pairs of row and column coordinates match, the output bit SP is set to a logical value “1.” If the two pairs of row and column coordinates do not match, the output bit SP is set to the logical value “0.” The output of comparator 23 is updated once per cycle of clock “clk.”

The bit “SP” is asserted from the output of comparator 23 to counter 21 and to circuit 15. In response to the bit “SP,” the output of counter 21 is incremented and circuit 15 generates the next output image pixel (the next pixel of “RGB data”) in each cycle of clock “clk” in which the bit “SP” has the logical value “1,” and the output of counter 21 is not incremented and circuit 15 does not generate a next output image pixel (a next pixel of “RGB data”) in each cycle of clock “clk” in which the bit “SP” has the logical value “0.”

Circuits 14 and 16 of FIG. 3 are configurable in response to configuration bits indicative of the format of the input image data and the desired format of the output image data.

Preferably, the FIG. 4 circuit is implemented to have a pipelined architecture having pipelined instruction execution stages.

It should be understood that while some embodiments of the present invention are illustrated and described herein, the invention is defined by the claims and is not to be limited to the specific embodiments described and shown.

What is claimed is:

1. A method for de-mosaicing and downscaling image data in a single, integrated operation to generate output image data, said method including the steps of:
(a) determining sampling points of the image data, the sampling points including one sampling point for each pixel of the output image data; and
(b) filtering the image data to generate a set of color component values for each of the sampling points, each said set of color component values determining a different pixel of the output image data.

2. The method of claim 1, wherein the image data are in raw Bayer image format, the output image data are in RGB format, and step (b) includes the step of generating a red color component, a blue color component, and a green color component for each of the sampling points.

3. The method of claim 2, also including the step of displaying the output image data.

4. The method of claim 2, wherein the image data include 2W_{S}×2H_{S} pixels and the output image data include W_{D}×H_{D} pixels, where W_{S}, W_{D}, H_{S}, and H_{D} satisfy at least one of 2W_{S}>W_{D} and 2H_{S}>H_{D}, and step (a) includes the step of:
mapping each pixel of the output image data having row and column indices {n, m} to a pixel of the image data having row and column indices {N, M}, where n and N are row indices, m and M are column indices,
$$\begin{matrix}N = ⌊ \frac{2 {H}_{S}}{{H}_{D}} * n + 0.5 ⌋ , \\ M = ⌊ \frac{2 {W}_{S}}{{W}_{D}} * m + 0.5 ⌋ , and\end{matrix}$$
each pixel of the image data having row and column indices {N, M} is one of the sampling points.

5. The method of claim 4, wherein step (b) includes the step of:
generating the set of color component values for each of the sampling points in response to a block of pixels of the image data that is centered at said each of the sampling points.

6. The method of claim 4, wherein step (b) includes the step of:
generating the set of color component values for each of the sampling points having row and column indices {N, M} in response to a 5×5 block of pixels of the image data that is centered at said each of the sampling points.

7. The method of claim 6, wherein the image data determine an input image, all pixels of the input image have row indices within a row index range and column indices within a column index range,
each pixel of said 5×5 block of pixels having color C, a row index outside the row index range, and a column index Y in the column index range is a reflection of a pixel of the input image having the color C and said column index Y, and
each pixel of said 5×5 block of pixels having color C, a column index outside the column index range, and a row index X in the row index range is a reflection of a pixel of the input image having the color C and said row index X.

8. The method of claim 4, wherein the image data are in raw Bayer image format, the output image data are in RGB format, and step (b) includes the step of:
(c) generating a red color component, a blue color component, and a green color component that determine a pixel of the output image data having row and column indices {n, m}, for each of the sampling points having row and column indices {N, M} in response to a block of pixels of the image data centered at said each of the sampling points, wherein step (c) includes the step of:
(d) performing bi-linear interpolation on at least some pixels of the block centered at said each of the sampling points to determine the green color component.

9. The method of claim 8, wherein the image data determine an input image, and step (c) generates the red color component and the blue color component for said each of the sampling points having row and column indices {N, M} that is not a green pixel by:
(e) determining differences between pixels of the image data, including a difference between pixels of the image data having row and column coordinates {N+1, M} and {N−1, M} and a difference between pixels of the image data having row and column coordinates {N, M+1} and {N, M−1};
(f) calculating an interpolated green value for said each of the sampling points by interpolating along any edge of the input image determined by the differences determined in step (e);
(g) calculating one of the red and blue color components whose color matches that of said each of the sampling points having row and column coordinates {N, M} by adjusting said each of the sampling points in accordance with a difference between the interpolated green value determined in step (f) and the green color component determined in step (d) for said each of the sampling points;
(h) generating interpolated values of a second one of the red and blue color components by performing interpolation horizontally and vertically for each of four green pixels of the block centered at said each of the sampling points that are nearest to said each of the sampling points, where the four green pixels of the block that are nearest to said each of the sampling points are GS1 whose row and column coordinates are {N, M−1}, GS2 whose row and column coordinates are {N, M+1}, GS3 whose row and column coordinates are {N−1, M}, and GS4 whose row and column coordinates are {N+1, M}, and determining a difference set such that each element of the difference set is a difference between one of the interpolated values of the second one of the red and blue color components and a corresponding one of the green pixels GS1, GS2, GS3, and GS4; and
(i) determining the second one of the red and blue color components from the difference set determined in step (h) and the interpolated green value determined in step (f).

10. The method of claim 8, wherein the image data determine an input image, and step (c) generates the red color component and the blue color component for said each of the sampling points that is a green pixel by:
(e) determining differences between pixels of the image data, including a difference between pixels of the block centered at said each of the sampling points that are vertically nearest to a nearest upper neighbor of said each of the sampling points, a difference between pixels of said block that are horizontally nearest to the nearest upper neighbor of said each of the sampling points, a difference between pixels of said block that are vertically nearest to a nearest lower neighbor of said each of the sampling points, a difference between pixels of said block that are horizontally nearest to the nearest lower neighbor of said each of the sampling points, a difference between pixels of said block that are vertically nearest to a nearest left neighbor of said each of the sampling points, a difference between pixels of said block that are horizontally nearest to the nearest left neighbor of said each of the sampling points, a difference between pixels of said block that are vertically nearest to a nearest right neighbor of said each of the sampling points, and a difference between pixels of said block that are horizontally nearest to the nearest right neighbor of said each of the sampling points;
(f) calculating interpolated green values, including an interpolated green value for each of the nearest upper neighbor, the nearest lower neighbor, the nearest left neighbor, and the nearest right neighbor of said each of the sampling points by interpolating along any edge of the input image determined by the differences determined in step (e);
(g) determining a difference set such that each element of the difference set is a difference between one of the nearest upper neighbor, the nearest lower neighbor, the nearest left neighbor, and the nearest right neighbor of said each of the sampling points and a corresponding one of the interpolated green values determined in step (f); and
(h) calculating the red and blue color components of said each of the sampling points from the difference set determined in step (g) and the green color component determined in step (d) for said each of the sampling points.

11. The method of claim 8, wherein each said block of pixels is a 5×5 block of pixels.

12. The method of claim 1, also including the step of displaying the output image data.

13. The method of claim 1, wherein the image data are in raw Bayer image format, and step (b) implements an edge adaptive interpolation algorithm and performs color correlation between red and green channels of the input data and between blue and green channels of the input data to reduce aliasing artifacts.

14. The method of claim 1, wherein step (b) generates a red color component value, a green color component value, and a blue color component value for each of the sampling points.

15. A circuit configured to perform de-mosaicing and downscaling of image data in a single, integrated operation to generate output image data, wherein the image data determine an input image, said circuit including:
a sampling point determining subsystem configured to determine sampling points of the image data, said sampling points including one sampling point for each pixel of the output image data;
a block generating subsystem coupled and configured to receive the image data and to generate blocks of the image data, wherein each block of at least a subset of the blocks consists of pixels of the image data centered at a different one of the sampling points; and
an output image data generating subsystem coupled to the sampling point determining system, coupled to receive the blocks of the image data and configured to filter at least some of the image data, in each of said blocks that consists of pixels of the image data centered at one of the sampling points, to generate a set of color component values for said one of the sampling points, wherein each said set of color component values determines a different pixel of the output image data, and the color component values for all of the sampling points determine a de-mosaiced and downscaled version of the input image.

16. The circuit of claim 15, wherein the block generating subsystem includes:
a buffer memory configured to buffer rows of the image data; and
circuitry coupled to the buffer memory and configured to generate the blocks of the image data in response to pixels of the image data read from the buffer memory and additional pixels of the image data.

17. The circuit of claim 16, wherein each of the blocks is a 5×5 block of pixels of the image data, and the buffer memory is configured to buffer four rows of the image data.

18. The circuit of claim 15, wherein the image data are in raw Bayer image format, the output image data are in RGB format, and the output image data generating subsystem is configured to generate a red color component, a blue color component, and a green color component for each of the sampling points.

19. The circuit of claim 18, wherein the image data include 2W_{S}×2H_{S} pixels and the output image data include W_{D}×H_{D} pixels, where W_{S}, W_{D}, H_{S}, and H_{D} satisfy at least one of 2W_{S}>W_{D} and 2H_{S}>H_{D}, the sampling point determining subsystem is configured to determine the sampling points by mapping each pixel of the output image data having row and column indices {n, m} to a pixel of the image data having row and column indices {N, M}, where n and N are row indices, m and M are column indices,
$$\begin{matrix}N = ⌊ \frac{2 {H}_{S}}{{H}_{D}} * n + 0.5 ⌋ , \\ M = ⌊ \frac{2 {W}_{S}}{{W}_{D}} * m + 0.5 ⌋ , and\end{matrix}$$
each pixel of the image data having row and column indices {N, M} is one of the sampling points.

20. The circuit of claim 19, wherein the output image data generating subsystem is configured to generate the red color component, the blue color component, and the green color component for each of the sampling points in response to one of the blocks of the image data that is centered at said each of the sampling points.

21. The circuit of claim 15, wherein each of the blocks is a 5×5 block of pixels of the image data.
